(19) United States
(12) Patent Application Publication
(10) Pub. No.: US 2012/0173259 A1
(43) Pub. Date: Jul. 5, 2012

(54) System and Method for Scheduling Medical Procedures

(75) Inventors: Paul H. Amberg, Waukesha, WI (US); Crispian Sievenpiper, Waukesha, WI (US); Sandra Wiley, Waukesha, WI (US)

(73) Assignee: General Electric Company, Schenectady, NY (US)

(21) Appl. No.: 12/984,185

(22) Filed: Jan. 4, 2011

(51) Int. Cl. G06Q 50/00; G06Q 10/00

(52) U.S. Cl. 705/2

(57) ABSTRACT

Present embodiments are directed to a system and method for calculating an estimated procedure time. Specifically present embodiments include systems and methods for estimating a procedure time for a patient to undergo an imaging procedure. The estimated procedure time may be calculated with a difficulty score that is used to adjust a base procedure time associated with a procedure protocol for the imaging procedure. Present embodiments are also directed to scheduling an amount of time corresponding to the estimated procedure time on a schedule.

### BACKGROUND OF THE INVENTION

The subject matter disclosed herein relates to systems and methods for scheduling medical procedures. More specifically, present embodiments are directed to scheduling examination times for imaging procedures.

Medical procedures are frequently scheduled to provide patients with some level of certainty regarding their personal schedules and to allow access to equipment that is scarce. Indeed, due to the scarcity of certain medical equipment, it is often desirable to schedule time with such equipment to control access and prevent overwhelming wait times. Specifically, for example, it is often desirable to schedule time for utilization of imaging equipment that is very expensive and in short supply. Traditionally, this is done by scheduling fixed blocks of time for each patient to be examined using the imaging equipment. For example, depending on the nature of the examination procedure to be performed on a particular patient, a magnetic resonance imaging machine may be scheduled for use in 20 or 30 minute blocks. For example, a patient undergoing a complicated procedure may be scheduled for 30 minutes while a patient undergoing a relatively simple procedure may be scheduled for 20 minutes. The allotted time may be based on a protocol that reflects a procedure time, which may be defined to include the time spent between a patient entering a procedure room and exiting the procedure room.

### BRIEF DESCRIPTION OF THE INVENTION

In accordance with one aspect of the present technique, a computer-assisted method is provided. The method includes receiving, on a computer, a difficulty score associated with a patient, wherein the difficulty score is based on patient characteristics. Additionally, the method includes receiving, on the computer, protocol data associated with a procedure the patient is being scheduled to undergo, wherein the protocol data includes a base procedure time. The method also includes calculating, with the computer, an estimated procedure time for the patient to undergo the procedure by using the difficulty score to adjust the base procedure time. Further, the method includes scheduling an amount of time corresponding to the estimated procedure time on a procedure schedule.

In accordance with one aspect of the present technique, a system including a scheduling station for an imaging procedure is provided. The scheduling station includes a processor and a memory storing a predictive calculator and a scheduler that are each configured to be activated by the processor. The predictive calculator is configured to calculate an estimated procedure time for a patient to undergo an imaging procedure based on a difficulty score assigned to the patient, and based on protocol data that includes a base procedure time. The scheduler is configured to schedule an amount of time corresponding to the estimated procedure time on a procedure schedule.

In accordance with one aspect of the present technique, a non-transitory, computer-readable medium, comprising code stored on the medium is provided. The code is configured to calculate an estimated procedure time for a patient to undergo an imaging procedure using a difficulty score assigned to the patient based on patient characteristics, wherein the difficulty score is utilized to adjust a base procedure time associated with a procedure protocol for the imaging procedure. The code is also configured to schedule an amount of time corresponding to the estimated procedure time on a schedule.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a process flow diagram of a scheduling procedure in accordance with present embodiments;

FIG. 2 illustrates a bar graph of empirical data with time represented by a Y-axis and patient age represented by an X-axis, wherein the bar graph represents empirical data that may be utilized in accordance with present embodiments;

FIG. 3 illustrates a bar graph of empirical data with time represented by a Y-axis and patient weight represented by an X-axis, wherein the bar graph represents empirical data that may be utilized in accordance with present embodiments; and

FIG. 4 illustrates a computer system for scheduling patient procedures in accordance with present embodiments.

### DETAILED DESCRIPTION OF THE INVENTION

Embodiments of the present disclosure are directed to facilitating efficient utilization of medical equipment and efficient appointment scheduling. Thus, present embodiments may enable efficient use of scarce equipment (e.g., imaging equipment) for a large number of patients and efficient control of patient waiting time. This may be achieved by making correlations between patient characteristics and examination times, and reflecting such correlations in a schedule.

It is now recognized that certain patient characteristics generally have a direct correlation to examination times. For example, it is now recognized that examination times for radiology patients vary widely due to differences in patient health, imaging protocols, age, weight, and other factors. Accordingly, when different radiology patients are each merely assigned the same amount of time for a particular imaging procedure or protocol, variances in actual procedure times result in inefficiencies. Specifically, long wait times may result when examinations exceed the allotted times in a schedule for particular protocols. For example, if the actual procedure for using imaging equipment on a particular patient takes more than the allotted time based on protocol, patients scheduled for later examination using the same imaging equipment may have to wait beyond their originally scheduled appointment times. Similarly, when the examination time for a patient is shorter than the allotted time, scarce equipment may not be utilized efficiently. For example, if a patient's imaging procedure is completed early relative to an allotted time, the imaging equipment may sit idle for the balance of time because a subsequently scheduled patient has not yet been prepared for examination. Present embodiments address this by allotting procedure time to patients based on certain patient characteristics, procedure protocols, and so forth that correlate to typical procedure times. This allotted procedure time is then incorporated into a schedule that is more accurate and efficient for equipment use and patient waiting time.

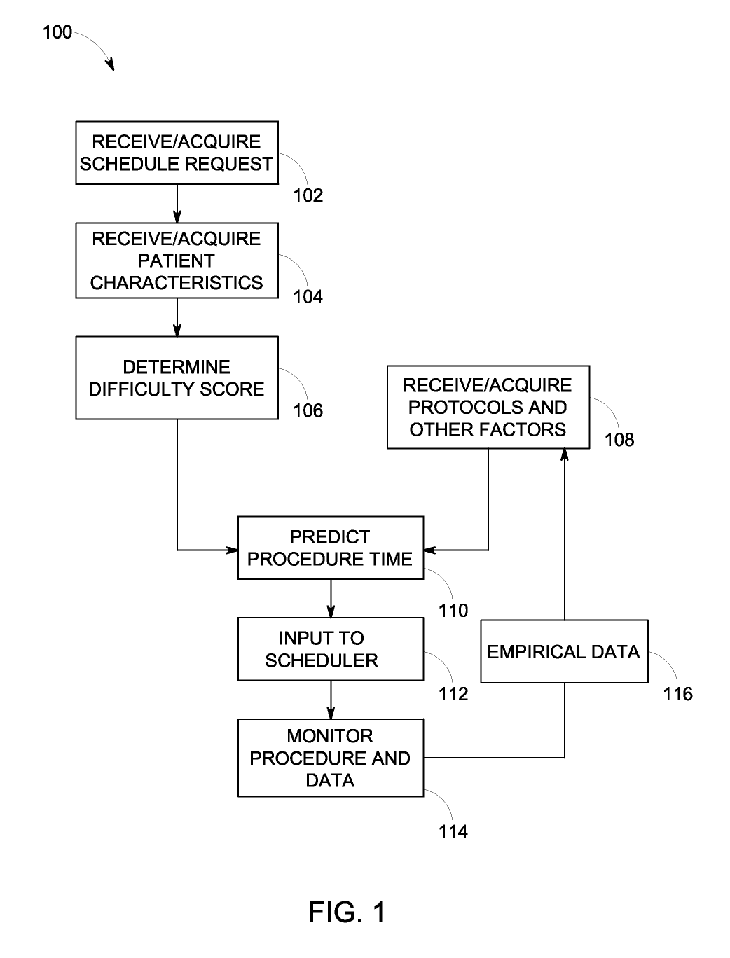

FIG. 1 illustrates a process flow diagram of a scheduling procedure 100 in accordance with present embodiments. The procedure 100 includes various different process steps, method steps, or actions, which are illustrated by blocks of the process flow diagram. The procedure 100 begins with receiving a request to schedule a patient for a particular procedure, as represented by block 102. This may include a computer and/or a software application stored on a non-transitory, computer-readable medium (e.g., a memory) receiving a request to schedule a timeslot or calendar entry for a particular patient to be examined using medical equipment that has limited availability, such as a magnetic resonance imaging (MRI) machine or computed tomography (CT) machine. For example, a healthcare worker (e.g., a nurse) may open a calendaring software application on a computer and enter a request to schedule an appointment with the MRI machine for the patient. In some embodiments, the patient may be able to request the appointment directly (e.g., via an Internet scheduling application). The computer may receive the request and output a confirmation that the request has been received or an indication of dates that are available. Once a date is selected, a time slot may be scheduled based on patient characteristics, examination protocols, and so forth in accordance with present embodiments. In some embodiments, the computer may simply receive a schedule request and proceed to a determination of patient characteristics, examination protocol, and so forth, as will be discussed below, and all scheduling may be performed based on such data.

After a schedule request has been received, the procedure 100 includes inputting or receiving information about the patient's characteristics, as represented by block 104. For example, the computer may be configured or programmed to request input regarding certain patient characteristics. Specifically, for example, the computer may request input regarding the patient's mobility, physical ability, weight, age, medical condition, level of compliance with verbal instruction, cognitive function, understanding, and/or the examination to be performed on the patient. In one embodiment, a healthcare worker may be asked to input a summary value or individual values for one or more of these patient or procedural attributes. For example, based on an overall assessment of the patient, the healthcare worker may provide an overall value for the patient's difficulty score. In another embodiment, a healthcare worker may be asked as series of questions about the patient and the healthcare worker's answers may be utilized by a computer feature including an algorithm configured to assign scores for each characteristic or the overall patient based on the answers. As represented by block 106, the overall value provided by the healthcare worker or a series of inputs may be utilized with or without otherwise known information about the patient to assign an overall difficulty level or score to the patient that corresponds to an estimated amount of time required to perform the examination. For example, characteristics of the patient that may have an effect or impact on the ability of the patient to undergo medical testing and the amount of time taken to have the testing performed may be input or received by the computer, and the computer may be configured to assign a difficulty score for the patient.

A difficulty level or score in accordance with present embodiments may be described as a relative value assigned to a patient's abilities and condition as a cumulative score based on several groups (e.g., 4 groups) of patient attributes. The groups of patient attributes may include: (1) mobility and physical ability (“mobility”), (2) medical condition, (3) cooperation or level of compliance to verbal instruction (“cooperation”), and (4) cognitive function or understanding (“cognitive function”). Each of these groups of patient attributes have been found to have a likely impact on the time and effort required to have a diagnostic or testing procedure performed on the patient. A defined number of levels or scores may be utilized to identify and summarize patient attributes. By assigning a specific value to the patient's condition, present embodiments facilitate consistent communication between healthcare workers and computer applications. For example, six levels (e.g., scores 0, 1, 2, 3, 4, and 5) may be utilized to rank patient characteristics in each of the four groups of patient attributes set forth above. When each of several patient attribute groups is ranked separately, the ranking may be referred to as a component difficulty ranking or score for each attribute. When an overall ranking is acquired, the ranking may be referred to as an overall difficulty ranking or score.

Each of the patient attribute groups may be defined to include particular patient characteristics that can be gauged by a healthcare worker and/or a computer algorithm to establish or define a patient difficulty level. Indeed, a healthcare worker may assign scores based on observation of patient characteristics and a scaling system. Further, a machine (e.g., a programmed computer) may be configured to assign a score based on inputs regarding certain patient characteristics and a scaling table. Mobility may be gauged based on a degree to which a patient is able to maneuver (e.g., walk). For example, a patient that is able to maneuver normally may be assigned a component difficulty score of 0 for mobility, while a patient that is completely bedridden may be assigned a component difficulty score of 5 for mobility. Medical condition may be gauged based on a degree of illness, a severity or acuity of a condition, whether intravenous therapy is being employed, a level of consciousness, and/or a degree of infection or isolation. If the patient is well, the patient may receive a low component difficulty score (e.g., 0) for condition. However, if the patient has an illness that is judged to be severe or the patient is receiving therapy (e.g., intravenous therapy) that can make handling the patient cumbersome, the patient may receive a high component difficulty score (e.g., 5). Cooperation may be gauged based on the patient's ability to follow verbal instructions (e.g., instructions for the patient to hold his or her breath or to hold a specific position). If the patient is able to respond well to verbal instruction, the patient may be assigned a low component difficulty score for cooperation, while a patient that resists or simply does not respond to verbal instruction may be assigned a higher component difficulty score. Cognitive function may be gauged based on the patient's ability to articulate and answer questions. For example, a newborn will be given a high component difficulty score for cognitive function, while a fully awake and normally functioning adult will likely be given a low component difficulty score for cognitive function.

In some embodiments, an overall difficulty score may be assigned to a patient by a healthcare worker or programmed computer based on a cumulative assessment of the patient's characteristics. Indeed, based on certain observations, the overall patient's difficulty level may be assigned without considering component scores. The following are examples of assessed overall difficulty scores at each level and corresponding patient characteristics: (Level 0)—patient is able to walk without assistance, communicate, fully cooperate, and follow verbal instructions; (Level 1)—patient is able to walk with some assistance, and is generally able to communicate and cooperate; (Level 2)—patient requires a wheelchair, needs significant help standing and getting on a table, and has a catheter; (Level 3)—patient must be transported by stretcher or gurney, patient is alert and able to follow instructions but needs one or two staff members to facilitate positioning; (Level 4)—patient must be transported by stretcher with multiple drainage tubes, catheters and so forth, has limited to no ability to cooperate, communication is difficult or impossible, and two or more staff members are required to assist the patient; and (Level 5)—patient is combative, requires restraint, severely confused, unable and/or unwilling to cooperate or follow instructions, and requires multiple staff members to position. These are examples of assessments of patient characteristics. It should be noted that other combinations of characteristics may be defined to correspond to different overall difficulty scores. Indeed, overall difficulty scores may be based on empirical data tables including component scores and associated patient characteristics.

In some embodiments, once a difficulty score has been assigned to each of the patient attribute groups, an overall difficulty score may be defined, as represented by block 106. This overall difficulty score may be based on an average of the scores for the different groups or based on a weighted algorithm. The weighted algorithm may assign heavier or lighter weights to certain patient characteristics based on relevance to a particular examination type or based on general importance to procedure times. For example, a patient may have the highest component difficulty score for a cognitive function characteristic, but the patient may have low difficulty scores in every other category, and an algorithm may be configured to weight the score associated with cognitive function equally with the other characteristic scores such that the patient retains a fairly low overall difficulty score. However, if a patient has low difficulty scores in every category except cooperation, which is deemed particularly important for a particular procedure or any procedure, the algorithm may weight the cooperation score more heavily such that the patient is given an overall difficulty score that is near or equal to the cooperation score. Indeed, such weighting may be justified because a combative patient may be able to maneuver but the patient's ability to maneuver may not reduce the overall difficulty associated with examining the patient in a timely manner. It should be noted that score weighting may be based on empirical data (e.g., data acquired over time that indicates certain patient characteristics have a higher impact on procedure time than others). For example, empirical evidence may suggest that a particular procedure is more impacted by high difficulty scores than another procedure.

Once acquired, the difficulty score is utilized with other information to estimate an amount of time to allot for a patient's procedure time. For example, protocol information (e.g., a baseline procedure time value associated with a particular procedure) and other factors (e.g., age and weight of the patient) may be entered or retrieved from a database for the patient, as represented by block 108, and the difficulty score may be utilized with the protocol and other factors to estimate procedure time, as represented by block 110. Specifically, for example, block 110 may represent taking a base time allotment for a particular protocol (e.g., a standard time estimate for using an MRI machine to image a patient's knee) and increasing or decreasing the base time allotment by a fixed amount or a percentage of the base time allotment based on the difficulty score of the patient determined in block 112. In one embodiment, for example, an overall difficulty score corresponds to a multiplier (e.g., an overall difficulty score of 0 corresponds to a 1.0 multiplier, an overall difficulty score of 1 corresponds to a 1.2 multiplier, an overall difficulty score of 2 corresponds to a 1.4 multiplier, and so forth), and these multipliers may be multiplied by the base time for a procedure to provide an estimated procedure time for a particular patient. Specifically, for example, a patient with an overall difficulty score of 1 that is going to receive an examination with a base time of 20 minutes may be estimated to require a 24 minute procedure time based on a 1.2 multiplier associated with the overall difficulty score of 1. In another embodiment, a difficulty score may simply correspond to addition of a fixed amount of time. For example, a difficulty score of 2 may indicate that 10 minutes should be added to a base protocol time. In some embodiments, a combination of such compensations may be applied or a complex algorithm may be employed based on empirical data.

As set forth above, in some embodiments, the overall difficulty score or component difficulty scores may be correlated to time adjustments, weighted relative to other component scores, weighted relative to a predictive algorithm, and so forth, based on empirical data. Indeed, such empirical data may be continuously acquired and utilized for estimating procedure times. For example, difficulty scores for actual patients may be utilized with data relating to the type of procedure performed (e.g., a specific type of MRI and/or CT test) and the measured length of procedure time, which may include time between patients, to establish the empirical data and a predictive model. In addition to patient characteristics that have been automatically incorporated into a difficulty score or otherwise entered by a healthcare worker, present embodiments may also take into account different variables. For example, empirical data may reflect that a particular MRI machine tends to require more time than another MRI machine to perform a procedure, and this empirical data for the particular MRI machine that the patient is scheduled to use may be employed when estimating the procedure time. As another example, a particular healthcare worker may tend to overvalue or undervalue overall difficulty scores or particular component difficulty scores, and present embodiments may empirically observe and account for the tendencies of the particular healthcare worker. Specifically, for example, a healthcare worker may enter their name before assessing a patient and the healthcare worker's name may be tracked to determine a correlation between the healthcare worker's assessments and actual procedure times. If the healthcare worker's assessments are generally overly high or low relative to actual procedure times and standard assessments, the healthcare worker's assessments may be adjusted accordingly. Difficulty scores and predictive modeling algorithms may be continuously adjusted based on continuously acquired empirical data. Indeed, procedure times may be automatically monitored and incorporated into empirical data tables that are utilized to adjust procedure time modeling in accordance with present embodiments.

Predictive models in accordance with present embodiments may take into account the type of procedure (e.g., established procedural protocols), the overall difficulty score of the patient, and other data to estimate an amount of time required for the patient to have a procedure performed. Specifically, for example, a difficulty score for a particular patient may be used to adjust a base time associated with a particular procedure that the patient is going to undergo by using the difficulty score in a predictive model for the particular procedure. Different procedures may be associated with different predictive models because the impact of the difficulty score may vary for different procedures. Indeed, certain procedures may be more heavily impacted than others when a patient's difficulty score is high. Further, in accordance with some embodiments, a difficulty score may be calculated differently depending on the procedure the patient is being scheduled to undergo because of varying correlations between patient attribute groups. For example, one type of procedure may rely heavily on the patient complying with verbal instructions. Accordingly, the predictive model associated with this procedure may heavily weight the difficulty score for the cooperation attribute group.

Once a predicted procedure time is acquired, as illustrated by block 110, the predicted procedure time is utilized to schedule a timeslot for the patient to undergo the procedure with the appropriate equipment. More specifically, the timeslot is entered into a scheduler, as illustrated by block 112. The input to the scheduler in block 112 may include updating an electronic calendaring application that enables selection of available time slots based on the predicted duration of a patient's exam and other factors. For example, a user may indicate that the patient is available on certain days and the scheduler may take this information into account along with the predicted duration time of the exam to establish an appointment time for the patient's procedure. The input to the scheduler may then be accessed by medical equipment operators (e.g., MRI machine operators) and so forth. Further, the actual procedure may be monitored and other data may be accounted for (e.g., personnel involved, equipment utilized), as represented by block 114, and related empirical data 116 may be supplied as other factors for use in calculating or predicting future procedure times.

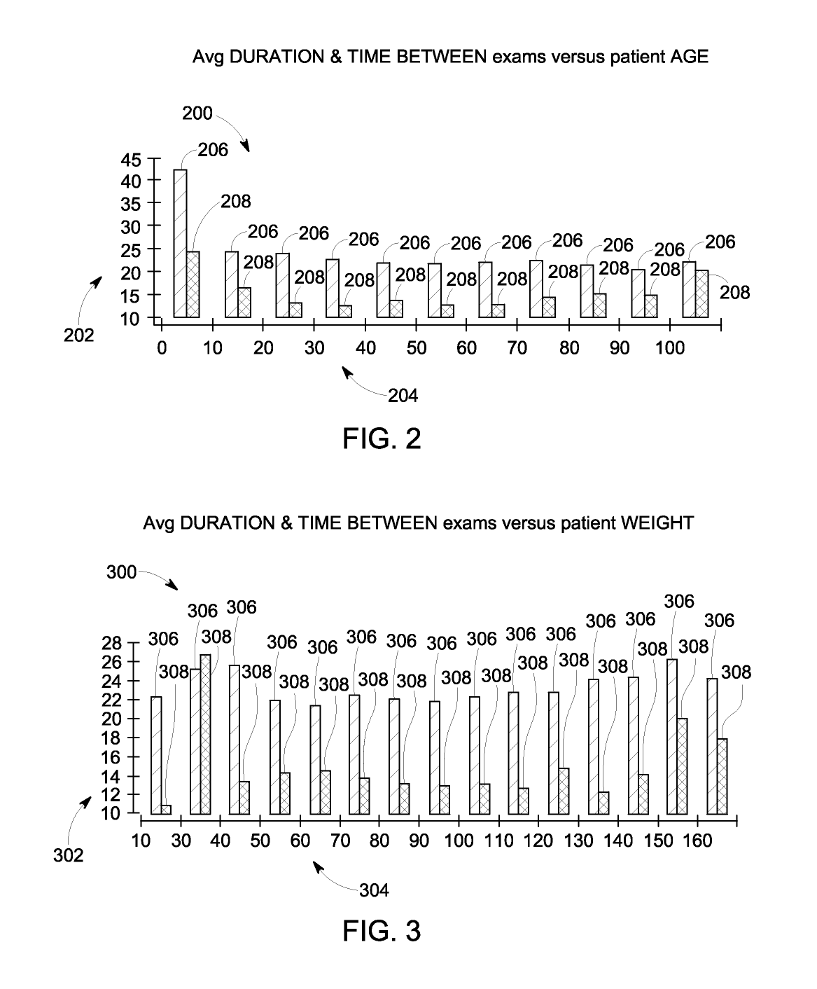

In addition to the patient characteristics set forth in the patient attribute groups above, additional information may be utilized in predictive algorithms or to acquire a patient's difficulty score. For example, patient age and weight may entered or acquired from an electronic patient file and utilized to establish the difficulty score or may be used along with the difficulty score in a predictive algorithm. Indeed, patient age and weight have been observed to correlate with examination time and/or time between examinations (e.g., transition time). For example, FIG. 2 illustrates a bar graph 200 with time represented by a Y-axis 202 and patient age represented by an X-axis 204. Values for examination duration time and time between examinations are represented by bars 206 and 208, respectively. The data represented in the bar graph 200 indicates that examination duration time (206) is higher for patients in the lowest age group. However, examination duration time (206) remains fairly consistent for the other age groups. This is not the case for time between examinations (208) which gradually increases at each end of the spectrum of age groups. Indeed, according to the empirical data illustrated in FIG. 2, young children and elderly people tend to have a longer time between examinations (208). As another example, FIG. 3 illustrates a bar graph 300 with time represented by a Y-axis 302 and patient weight represented by an X-axis 304. Examination duration time and time between examinations are represented by bars 306 and 308, respectively. The data represented in the bar graph 300 indicates that examination duration time (306) and time between examinations (308) both generally correlate to patient weight. Indeed, patients at either weight extreme tend to have longer associated times. Empirical data such as the data illustrated in FIGS. 2 and 3 may be utilized to provide a patient difficulty score or in a predictive algorithm (along with a separate difficulty score) to estimate a procedure time in accordance with present embodiments.

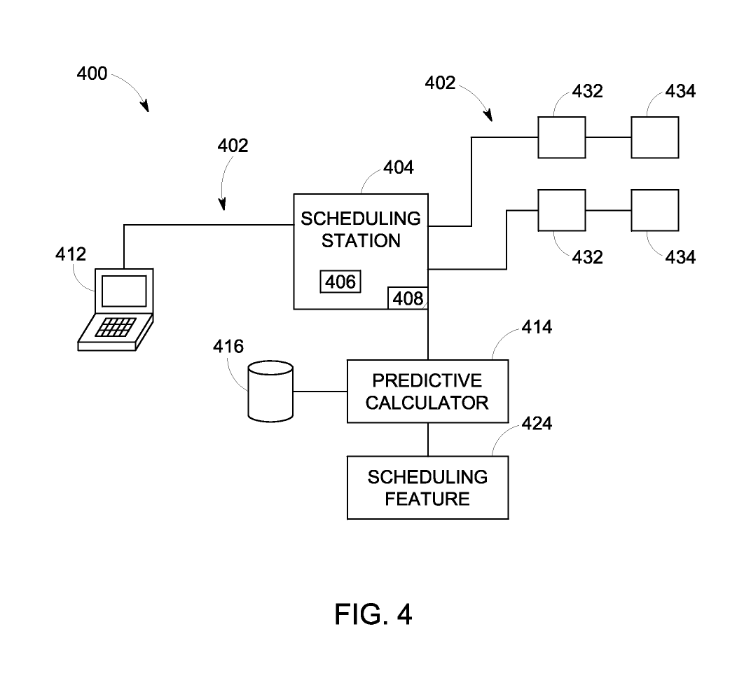

FIG. 4 illustrates a system 400 for scheduling patient procedures in accordance with present embodiments. The system 400 includes a network 402 in the illustrated embodiment. However, in other embodiments a single computer may be utilized. The system includes a scheduling station or computer 404, which includes a processor 406 and a memory 408 that cooperate to function as a scheduler in accordance with present embodiments. The memory 408, which is a non-transitory computer-readable medium, includes programming or code that is activated by the processor 406 such that the computer 404 is configured to or capable of estimating procedure times for particular patients in accordance with present embodiments.

In the illustrated embodiment, the system 400 includes a data entry station 412, which may include a laptop, desktop, or tablet computer that is connected to the network 402 wirelessly or via a network cable. Indeed, communications throughout the network 402 may be wireless or wired. The data entry station 412 may be utilized by a healthcare worker to input patient data that can be used to calculate an overall difficulty score for the patient or to simply input an overall difficulty score for the patient. For example, the healthcare worker may observe certain characteristics of the patient, estimate an overall difficulty score for the patient, and enter the score into the data entry station, which transmits the data to the scheduling station 404 via the network 402. In some embodiments, the data entry station 412 may present the healthcare worker with a series of yes or no questions (e.g., “Can the patient walk?”) or a series of ranking questions (e.g., “On a scale of 0 to 5, with 0 indicating the least difficulty and 5 indicating the most difficulty, how well can the patient maneuver?”), and the healthcare worker's responses may be utilized by the data entry station 412 or the scheduling station 404 to determine an overall difficulty score for the patient based on a predictive calculator 414.

Once acquired, the overall difficulty score or various component difficulty scores may be utilized by the scheduling station 404 in the predictive calculator 414 (e.g., a functional algorithm) stored on the memory 408 and activated by the processor 406 to predict or provide an estimated procedure time for the patient. It should be noted that in some embodiments, different aspects of a predictive calculation in accordance with present embodiments may be performed on the scheduling station 404 and/or the data entry station 412. In the illustrated embodiment, all such calculations are performed on the scheduling station 404. Indeed, the predictive calculator 414, which is stored on the scheduling station 404, may be configured to access a database 416 to facilitate calculation of estimated procedure times and/or patient difficulty scores. The data base 416 may include, for example, data related to the type of procedure the patient is being scheduled to undergo, empirical data relating to the patient's assigned overall difficulty score, empirical data relating to the patient's assigned component difficulty scores, other patient data (e.g., patient age and weight) and so forth to estimate a procedure time. Indeed, the predictive calculator 414 incorporates such data to provide a predictive estimate of a duration time. It should be noted that in some embodiments, difficulty score calculation and predictive calculations may be performed directly on the data entry station 412 and transmitted to the scheduling station 404.

Once an estimated procedure time has been established, the procedure time is transmitted to a scheduler or scheduling feature 424 that establishes or identifies a time slot in a schedule for the patient's procedure. In some embodiments, a date is entered for the procedure (e.g., a date is entered via the data entry station 412) and the scheduling feature 424 identifies an open slot during the selected date that provides sufficient time for the patient's procedure based on the estimated duration time. In other embodiments, the scheduling feature 424 simply looks for the first available time slot or schedules a time slot based on prioritizing efficient use of the equipment that will be utilized in the procedure. Indeed, the scheduling feature 424 may select time slots to efficiently address scheduling changes. For example, if a patient cancels an examination that was scheduled for 30 minutes and leaves a corresponding open slot in the schedule, the scheduling feature 424 is configured to identify schedule requests with similar duration time estimates to fill the open slot in accordance with present embodiments. Scheduling in this fashion enables proactive scheduling adjustments, optimization of equipment throughput, and optimization of patient waiting times.

An established schedule for at least one piece of examination equipment (e.g., an MRI machine) is stored on the scheduling station 404 such that it is accessible via the network 402 or via direct access to the scheduling station 404. In some embodiments, viewing stations 432 that may be positioned near or integral with certain examination equipment 434 may be utilized to access the scheduling station 404 in order to observe or utilize a schedule associated with the corresponding examination equipment 434. For example, in one embodiment, an MRI machine is located in the same room with a viewing station or the viewing station may be a part of the MRI machine, and the viewing station is capable of displaying a graphic representation of a schedule for procedures to be performed by the MRI machine. The viewing stations 432 may also be configured to modify the schedule. For example, an MRI machine operator may be able to adjust the schedule based on actual performance or even adjust a patient's difficulty score based on the patient's condition at the time of the procedure by entering changes via the viewing stations 432. Further, an operator of examination equipment 434 may be able to enter examination data (e.g., examination time data) via the viewing stations 432 for use as empirical data, or the examination equipment 434 may be configured to automatically report examination data (e.g., equipment time used) for use as empirical data in future predictive calculations of duration times for patients.

Technical effects of the invention include adjusting examination and procedural scheduling based on predictive measures associated with patient characteristics and protocol data. Further, present embodiments incorporate empirical data, which may be continuously acquired, to update correlations between patient characteristics and procedure times for predictive modeling. Additionally, present embodiments incorporate empirical data, which may be continuously acquired, to update correlations between non-patient related data (e.g., equipment identity, healthcare worker identity, procedure type, and so forth) and procedure times for predictive modeling. Present embodiments facilitate more accurate estimation of the time required for medical procedures (e.g., radiology imaging procedures) relative to existing techniques. Accordingly, present embodiments facilitate more efficient use of equipment, proactive scheduling adjustments, and efficient use of patient time.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-assisted method, comprising:
receiving, on a computer, a difficulty score associated with a patient, wherein the difficulty score is based on patient characteristics;
receiving, on the computer, protocol data associated with a procedure the patient is being scheduled to undergo, wherein the protocol data includes a base procedure time;
calculating, with the computer, an estimated procedure time for the patient to undergo the procedure by using the difficulty score to adjust the base procedure time; and
scheduling an amount of time corresponding to the estimated procedure time on a procedure schedule.

2. The method of claim 1, comprising calculating, with the computer or a different computer, the difficulty score based on answers to a series of computer-prompted questions.

3. The method of claim 1, comprising calculating the difficulty score by incorporating a plurality of component difficulty scores associated with the patient characteristics.

4. The method of claim 1, comprising calculating the difficulty score based on a plurality of component difficulty scores that are weighted based on a type of the procedure.

5. The method of claim 1, wherein using the difficulty score comprises acquiring a multiplier from a data table based on the difficulty score and multiplying the multiplier by the base procedure time to calculate the estimated procedure time.

6. The method of claim 1, wherein calculating the estimated procedure time comprises adding a value associated with the difficulty score to the base procedure time.

7. The method of claim 1, wherein calculating the estimated procedure time comprises adjusting the base procedure time based on empirical data.

8. The method of claim 7, comprising tracking a time required for the procedure and updating the empirical data based on the time required for the procedure and the difficulty score.

9. The method of claim 1, wherein calculating the estimated procedure times comprises adjusting the base procedure time based on an algorithm incorporating empirical data, wherein the empirical data includes patient weight, patient age, identities of healthcare personnel involved in the procedure, equipment identification information, or a combination thereof.

10. The method of claim 1, comprising prompting a user to input values or answers corresponding to the patient characteristics including mobility, medical condition, cooperation, and cognitive function, and calculating the difficulty score based on the values or answers.

11. A system, comprising:
a scheduling station, wherein the scheduling station comprises:
a processor;
a memory storing a predictive calculator and a scheduler that are each configured to be activated by the processor,
wherein the predictive calculator is configured to calculate an estimated procedure time for a patient to undergo an imaging procedure based on a difficulty score assigned to the patient and based on protocol data that includes a base procedure time, and
wherein the scheduler is configured to schedule an amount of time corresponding to the estimated procedure time on a procedure schedule.

12. The system of claim 11, comprising a data entry station configured to receive input related to the difficulty score and provide the input to the scheduling station.

13. The system of claim 12, wherein the input comprises a value for the difficulty score, a plurality of component difficulty scores, or answers to questions that the scheduling station can utilize to calculate the difficulty score.

14. The system of claim 11, comprising an imaging machine configured to perform the imaging procedure and to monitor empirical data for transmission to the scheduling station for use in calculating future estimated procedure times.

15. The system of claim 11, comprising a plurality of viewing stations configured to observe and/or manipulate the procedure schedule.

16. A non-transitory, computer-readable medium, comprising code stored on the medium configured to:
calculate an estimated procedure time for a patient to undergo an imaging procedure using a difficulty score assigned to the patient based on patient characteristics, wherein the difficulty score is utilized to adjust a base procedure time associated with a procedure protocol for the imaging procedure; and
schedule an amount of time corresponding to the estimated procedure time on a schedule.

17. The non-transitory, computer-readable medium of claim 16, wherein the code stored on the medium is configured to calculate the difficulty score based on inputs related to the patient characteristics.

18. The non-transitory, computer-readable medium of claim 16, wherein the code stored on the medium is configured to prompt a user to enter a value of 0, 1, 2, 3, 4, or 5 for the difficulty score based on the patient characteristics.

19. The non-transitory, computer-readable medium of claim 16, wherein the code stored on the medium is configured to access a database stored on the medium to acquire data utilized in calculating the estimated procedure time.

20. The non-transitory, computer-readable medium of claim 16, wherein the code stored on the medium is configured to acquire empirical data from an imaging machine to update a database of empirical data stored on the medium and utilized in calculating the estimated procedure time.
